(19) United States
(12) Patent Application Publication
(10) Pub. No.: US 2021/0088009 A1
(43) Pub. Date: Mar. 25, 2021

(54) DEVICE HAVING AN ACTIVE COATING COMPRISING NANO CATALYST OF OXIDES OF TITANIUM, SILICON AND ALUMINUM FOR SAVING FUEL IN A COMBUSTION CHAMBER

(71) Applicant: Awad Rasheed Suleiman MANSOUR, Chicago Ridge, IL (US)

(72) Inventor: Awad Rasheed Suleiman MANSOUR, Chicago Ridge, IL (US)

(21) Appl. No.: 16/580,279

(22) Filed: Sep. 24, 2019

(51) Int. Cl. F02M 27/02; F02M 37/00; F02M 37/34; F02M 59/44; F02B 51/02; B01J 21/04; B01J 21/08; B01J 21/06; B01J 35/00

(52) U.S. Cl. CPC F02M 27/02; F02M 37/0017; F02M 37/34; F02M 59/44; B01J 35/0013; B01J 21/04; B01J 21/08; B01J 21/063; F02B 51/02

(57) ABSTRACT

The present invention relates to a fuel saving device for a combustion chamber comprising a coating on a surface in fuel passageway of the device through which the fuel to be entered and burnt in the combustion chamber flows, wherein the coating comprises nanosized particles of TiO₂, SiO₂ and Al₂O₃ in an epoxy coating composition.

### TECHNICAL FIELD OF THE INVENTION

The present invention relates to a device having a coating comprising nano oxides of titanium, silicon and aluminum which is applied on a surface in fuel passageways for efficient burning of a fluid fuel in a combustion chamber. More preferably, the invention relates to a device with a coating made of a thin epoxy layer comprising said mixture of nano oxides applied in fuel passageway for conditioning and catalyzing the fuel before entering into the combustion chamber.

### BACKGROUND OF THE INVENTION

It is known that burning efficiency of the combustion chambers such as internal combustion engines is in very low level such that the combustion is carried out inefficiently and inappropriately with incomplete and falsified burning reactions producing unburned hydrocarbons (HC), carbon monoxide (CO) and oxides of nitrogen (NOₓ). Unburned HC and NOx react in the atmosphere to form photo-chemical smog. Smog is highly oxidizing in the environment and is the prime cause of eye and throat irritation, bad odor, plant damage, and decreased visibility. Oxides of Nitrogen are also toxic. CO impair blood capability to carry oxygen to the brain, resulting in slower reaction times and impaired judgement.

There are plenty of attempts to modify the molecular arrangement of fuel to become finely divided but most of them amount to a small percentage of fuel saving. The present invention aims at obtaining of high percentage of saving and this been achieved with great success and drastic results as shown in the examples.

As an example, U.S. Pat. Nos. 3,830,621, 4,188,296, 4,461,262, 4,572,145, 5,331,807, 5,664,546 disclose magnetizing assemblies for the purposes set forth above which generally include a magnet, South pole of which is brought in close proximity with a fuel line so that the fuel molecules are reorganized for improving the burning efficiency. The magnetizing material is placed onto various components of a combustion system with different arrangements; however, the effect of these systems is mostly quite limited because the magnetic field as such is mostly insufficient for ionization and conditioning of the fuel molecules in a closed conduit system.

To explain the new theory of combustion in a simple manner; assuming one potato vegetable, cut it into 5 pieces and exposed to a frying process; it would take about 5 minutes to fry it. If the same potato is divided into 500 thin chips; frying of the same potato would take only seconds.

Similar process occurs when an active nano catalyst is used in the fuel line connecting fuel tank and combustion chamber, it breaks down fuel molecules into huge number of sub-molecules with huge number of surfaces exposed to direct combustion resulting in huge number of combustion processes and heating value. This is evidenced by real saving numbers documented by real readings in gas stations as shown in the Examples of the present description.

Therefore, the present invention solves a long felt need in this area by elimination of the problems encountered in fuel saving arrangements, with a system comprising nanosized particles according to the appended claims.

### SUMMARY OF THE INVENTION

The present invention provides a fuel saving device for a combustion chamber comprising a coating on a surface in fuel passageway of the device through which the fuel to be entered and burnt in the combustion chamber flows and comes into contact with said coating. The coating mentioned above comprises nanosized particles of TiO₂, SiO₂ and Al₂O₃ in an epoxy coating composition.

In particular embodiments the combustion chamber is an internal combustion engine. Particularly good results have been obtained with gasoline.

The nanosized particles of TiO₂, SiO₂ and Al₂O₃ have a particle size of less than 100 nm, and more preferably of between 10 and 100 nm.

The epoxy coating mentioned hereinabove can also be an epoxy paint coating. The device of the present invention may be advantageously designed as a fuel conduit, fuel pump, or fuel filter.

In another aspect, the present invention relates to a method for producing a fuel saving device for a combustion chamber comprising the steps of preparing nanosized particles of TiO₂, SiO₂ and Al₂O₃, mixing the same with an epoxy coating composition homogenously, and applying the resulting composition onto a surface in the fuel passageway of the device.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### DETAILED DESCRIPTION OF INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, biochemical and nanotechnology arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Technical problem to be solved by the present invention is to provide a device and fast assistant, which will accelerate ignition process, improve hydrocarbon combustion and prevent detonation, burning coke, in order the engine produces maximum efficiency, and saves gasoline consumption and reduces exhaust emissions.

These objects are achieved through a combined device comprising energetic nanoparticles which are found to be producing a very effective synergistic outcome if they are used together to modify a liquid fuel before usage in a combustion chamber. The system mentioned above is aimed to be used in any combustion chamber like internal combustion engine utilizing of liquid fuels, particularly of gasoline. The system can be placed on any component in a fuel supplying assembly such as the conduits, fuel pumps, filters and in a place before/after mixing chambers such as fuel injectors or carburetors.

Energetic nanoparticles according to the present invention are provided as a mixture of the oxides of the elements comprising Titanium, Silica and Aluminum. The oxides of titanium, silica and aluminum comprised in the coating as described herein are titanium oxide (TiO₂), silicon oxide (SiO₂) and alumina (Al₂O₃), respectively. In the context of the present invention, the term nanoparticle refers to small particles having a particle size less than 100 nm and more particularly between 10 and 100 nm. The proportion of each oxide in the mixture can be in amounts ranging between 0.01% to 99.00% to produce the desired effect. Such proportions can be arranged depending on the fuel type or costs of the oxides independently.

The inventor of the current invention unexpectedly found that the energetic nanoparticles as defined hereinabove behave as a catalyst if they are used in a thin epoxy coating layer. Said epoxy coating layer may comprise conventional epoxy resins and curing agents. Alternatively, epoxy paint coating compositions can be utilized in the present invention.

The catalyzing effect of the nanoparticles greatly enhances breaking down of the fuel molecules and reorganization thereof especially in a flowing fuel system by virtue of the passivated oxide layers characterized by a high rate of energy release. In particular, energetic nanoparticles offer a high volumetric heat of oxidation, enabling transportation of more energy per given fuel volume. They generally exhibit faster ignition timescales due to the dramatic increase in the surface-to-volume ratio, and can ignite below the bulk melting point of the metal due to rapid temperature gradients through their thin oxide layers. Nano-sized energetic particles offer the potential of controlled burning rates, increased combustion efficiencies, and reduced sensitivity. Therefore, the nanoparticles according to the present invention are arranged in a device in fluid communication with the liquid fuel. Due to this direct contact with the fluid, catalyzing effect is directly transferred to the fuel molecules without the limitations of the systems in prior art Therefore, the nanoparticles are provided in powder form which are mixed in an epoxy carrier for producing a coating. Thereafter, the coating is applied onto a surface of a device through which a liquid fuel comes into contact. The device can be embodied as a conduit, fuel pump, filter or any other component of the vehicle or engine which comes into contact with the liquid fuel before entering into the combustion chamber.

The nanoparticles according to this invention do not dissolve in hydrocarbon fuel, and therefore they offer a long term run in a particular device such as a conduit, fuel pump or fuel filter as mentioned above.

In another aspect, the present invention pertains to a method for preparing fuel saving device for a combustion chamber comprising the steps of preparing nanosized particles of TiO₂, SiO₂ and Al₂O₃, mixing the same with an epoxy coating composition homogenously and applying the resulting composition onto a surface in the fuel passageway of the device.

The inventor of the present invention has surprisingly found that the combined system according to the instant invention can produce the effects of making combustion almost complete (with unburned hydrocarbon less than 20 ppm), lowering gas consumption up to 95%, burning out carbon deposit, reducing gas pollution especially carbon monoxide (CO) which is reduced down to 0.0%, and increasing engine performance drastically.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

A mixture of TiO₂, SiO₂, and Al₂O₃ was provided with a particle size arrangement between 10 and 100 nm. The nanoparticles were then loaded into an epoxy carrier and mixed homogenously. The mixture was coated onto the inner surface of tubular fuel conduits supplying gasoline to the fuel injectors in automobiles of different brands.

Automobiles of different brands were also provided with regular fuel conduits each of which have been tested on a test road in identical conditions with constant speed, and fuel consumptions of the same have been recorded. The fuel conduits of the same vehicles were then replaced with the fuel conduits having active coating layer as mentioned above. After the testing procedure in identical conditions, fuel consumption values have been recorded and compared with the previous values.

The test road was a 50 miles street without traffic and any cause of slowing and acceleration. The fuel tanks of the vehicles have been filled up in the beginning of each test and filled up again at the end of the tests. The latter gave the fuel consumption values for each test.

### Example 1

A vehicle of the brand Ford Explorer (Model 2010) with 4000 cc engine has been tested on the test road with and without the activated fuel conduit.

| Fuel consumption | Fuel consumption |
|---|---|
| (without the activated fuel conduit) | (with the activated fuel conduit) |
| 5.28 gallon/50 miles | 2.36 gallon/50 miles |

Fuel Saving: 55%

### Example 2

Identical tests were carried out with the vehicles indicated below. Fuel saving results are indicated accordingly.

| | Fuel saving |
|---|---|
| Automobile | (%) |
| 1995 Hyundai Avante (1.5-liter engine) | 59.6 |
| 2012 Toyota Camry | 57.0 |
| 2006 Mitsubishi Lancer | 51.8 |
| 2010 Kia | 57.4 |
| 2008 Mercedes (1.8-liter engine) | 56.0 |
| 2006 Opel Omega (3.0-liter engine) | 55.6 |
| 2016 Mazda (2.0-liter engine) | 50.9 |
| 2002 Honda Civic (1.6-liter engine) | 72.1 |
| 2000 Honda Accord (3.0-liter engine) | 65.0 |

### Example 3

The 2006 Mazda (2.0-liter engine) mentioned above was tested by measuring the exhaust gases. The results were as follows:

| | |
|---|---|
| Carbon Monoxide (CO): | 0.0% |
| HC (Hydrocarbon): | 29 ppm |
| CO₂: | 14.8% |
| O₂: | 0.07% |
| H/C: | 1.85 |

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

1. A fuel saving device for a combustion chamber comprising a coating on a surface in fuel passageway of the device through which the fuel to be entered and burnt in the combustion chamber flows, wherein the coating comprises nanosized particles of TiO₂, SiO₂ and Al₂O₃ in an epoxy coating composition.

2. The device according to claim 1 wherein the combustion chamber is an internal combustion engine.

3. The device according to claim 1 wherein the fuel is gasoline.

4. The device according to claim 1 wherein the nanosized particles of TiO₂, SiO₂ and Al₂O₃ have a particle size less than 100 nm.

5. The device according to claim 4 wherein the nanosized particles have a particle size between 10 and 100 nm.

6. The device according to claim 1 wherein the epoxy coating is an epoxy paint coating.

7. The device according to claim 1 wherein the device is in the form of a fuel conduit, fuel pump, or fuel filter.

8. A method for producing a fuel saving device for a combustion chamber comprising the steps of preparing nanosized particles of TiO₂, SiO₂ and Al₂O₃, mixing the same with an epoxy coating composition homogenously, and applying the resulting composition onto a surface in the fuel passageway of the device.
